(19) United States
(12) Patent Application Publication
(10) Pub. No.: US 2017/0204642 A1
(43) Pub. Date: Jul. 20, 2017

(54) DOOR SECURITY DEVICE

(71) Applicant: Brian Tuzzio, West Milford, NJ (US)

(72) Inventor: Brian Tuzzio, West Milford, NJ (US)

(21) Appl. No.: 15/407,677

(22) Filed: Jan. 17, 2017

Related U.S. Application Data
(60) Provisional application No. 62/279,173, filed on Jan. 15, 2016.

(51) Int. Cl. E05C 19/00; E05B 47/00; E05B 15/16

(52) U.S. Cl. CPC E05C 19/001; E05B 15/1614; E05B 47/0001

(57) ABSTRACT

A security device and system is provided. The security apparatus has at least one first grommet, at least one second grommet, at least one attachment mechanism; and a securing member which has a height, a width, a thickness, and at least one cutout, having a first end and a second end. This attachment mechanism attaches the at least one first grommet to the at least one second grommet through at least one cutout, such that the security device may slide from said first end to said second end. The security system consists of a number of security apparatuses that are equipped with an automatic closing mechanism and a communications controller.

### CLAIM OF PRIORITY

This application claims the priority of U.S. Ser. No. 62/279,173 filed on Jan. 15, 2016, the contents of which are fully incorporated herein by reference in its entirety.

### FIELD OF THE EMBODIMENTS

The field of the present invention and its embodiments relate to an apparatus for securing a door. In particular, the present invention related to an apparatus that may easily be retro-fitted on an existing door that can secure this door while in use, and be unobtrusive when not in use.

### BACKGROUND OF THE EMBODIMENTS

Unfortunately, the need to quickly and effectively lock down schools and other buildings containing large amounts of people has dramatically increased in the past few years. As more and more of these unfortunate situations occur, the need for a device that can help prevent these incidents will grow proportionally. Many of the suggestions as to how to avoid these situations involve increasing police presence, installing more metal detectors at entrances, arming the people within the building, and other unsavory methods, particularly when implemented around masses of children.

While not foolproof, one way of preventing an intruder from running amok in a building is to prevent the intruder from entering the building in the first place. Placing reinforcements on doors, windows, and other potential entryways can serve to be very effective and limiting the impact of an intruder's actions on the occupants of a building. However, there are high costs associated with reinforcing entrances, especially when reinforced with heavy metals, which can be very costly to install, and may be too heavy for older structures not designed to support such weight. Further, there exist many situations where putting intimidating reinforcements on doors and windows would cause more harm and disruption than the benefit they would provide. In an environment that is supposed to be a safe and friendly environment, taking the necessary precautions to protect the occupants of the classroom using existing technology could have dramatic collateral effects.

As such, there exists for a lightweight, effective, inexpensive, and unobtrusive way to secure an entrance.

Review of related technology:

U.S. Pat. No. 9,133,655 pertains to a multistage lock has a stationary frame, an inner frame, an outer frame mounted between the stationary and inner frames, multiple stops mounted on the stationary and inner frames, two sliding panels mounted on the outer frame and a handle assembly connected to the sliding panels. Stopping protrusions of the stops selectively engage limiting protrusions on the sliding panels when the at least one handle is turned. Consequently, the inner and outer frames are selectively opened. The multistage lock has a simplified structure and allows people to decide whether a door panel (window) is open according to situations and weather outdoors.

U.S. Pat. No. 2,130,216 pertains to locking bars for doors and particularly to an improved construction for looking a sliding door, an object being to provide a simple construction which will clamp the door against the building or its frame at both sides when the bar is fully functioning.

United States Patent Publication No. 2014/0306464 pertains to door security device for preventing opening of a door. A first device includes a bar that seats against a doorframe on opposite sides of the door and a clamp that clasps a door latch and applies a force to draw the bar against the doorframe while pulling the door latch toward the bar. The door cannot be opened away from the bar. A second device has a bar that seats against a doorframe at the floor with a two plates that extend beneath the door and around to opposite sides of the doorframe. Removable pins or other locks obstruct the plates from sliding along the bar. The bar is tall enough that the door cannot pass over the bar, thus obstructing the door from opening inwardly. A closer cover slides over a mechanical door closing mechanism to be used alone or with the other devices.

United States Patent Publication No. 2012/0205920 pertains to an autonomous door defense system for use with a door moveable between open and closed positions, wherein the door is secured within a doorway, includes at least one brace assembly selectively moveable between at least a defense position, wherein a portion of the brace assembly is positioned to substantially prevent the door from being moved into the open position, and a standby position. The system further includes an activation assembly configured to move the at least one brace assembly between the at least defense and standby positions.

United States Patent Publication No. 2007/0170725 pertains to a combined sealing system for use with a combination of a panel and a frame includes a first sealing system and a second sealing system. The first sealing system is positioned within a first side of the frame, and the second sealing system is positioned within a second side of the frame separate from the first side of the frame. The first and second sealing systems have a locked configuration and an unlocked configuration upon the panel being positioned within the frame. The panel pivots relative to the frame, and the first sealing system is a reciprocal motion sealing system.

German Patent Document No. DE69709570 pertains to a lock mechanism that is mounted on the door and is located inside a housing made from U-section channelling elements. One element, attached to the door, is shorter than the full height of the door but is sufficiently long to enclose a common safety mechanism, and is covered by a trim strip in three sections. All of the trim strip sections are made from U-section channelling large enough to fit over the first element, and its two outer sections are able to slide inside the central one. Two additional U-section elements attached to the top and bottom of the door act as guides for the ends of the two outer sections of the trim strip. The first element and the central section of the trim strip have holes for the door handle, lock mechanism and bolts.

German Patent Document No. DE43445565 pertains to one of the two frames movable in relation to one another is a control curve, along which a pick-up is movable by a positioning component. The pick-up engages on the drive rod system and the control curve has at least one curve section for pick-up of the drive rod system via the pick-up. The control curve is arranged on the casement frame, and the pick-up is an extension of the positioning component drivable along the control curve. On the drive rod system is fixed a coupling component which can be brought into effective engagement with the extension of the positioning component serving as a pick-up.

International Patent Application No. WO2012109660 pertains to an autonomous door defense system for use with a door moveable between open and closed positions, wherein the door is secured within a doorway, includes at least one brace assembly selectively moveable between at least a defense position, wherein a portion of the brace assembly is positioned to substantially prevent the door from being moved into the open position, and a standby position. The system further includes an activation assembly configured to move the at least one brace assembly between the at least defense and standby positions.

Various systems and methodologies are known in the art. However, their structure and means of operation are substantially different from the present disclosure. The other inventions fail to solve all the problems taught by the present disclosure. The present invention and its embodiments provide a means to cheaply and effectively secure a door in a wide variety of settings. At least one embodiment of this invention is presented in the drawings below and will be described in more detail herein.

### SUMMARY OF THE EMBODIMENTS

The present invention provides for a security device that can function as either a primary or secondary means of protections in many environments such as in schools, in offices, in military installations, and in residences. In the event of a lockdown or other situation where securing a door or entryway is secured, the present invention easily slides and extends over the latch side of a door or other entryway. This extending over the latch side of the door will prevent the door from being kicked-in in a matter of seconds. Preferably, the present invention features a locking device to prevent tampering and to further secure the present invention in the closed position. In residential applications, the lip of present invention may be omitted such that the present invention may be tucked behind an interior trim, maintaining the room's design aesthetic. Preferably, the device will be sized to fit on standard 2″ steel door frames, and will still be capable of functioning even if the wall thickness extends beyond the depth of the frame. The performance of the door is not affected by installation of the present invention.

Specifically, the present invention provides for a security apparatus, comprising: at least one first grommet; at least one second grommet; at least one attachment mechanism; and a securing member, having a height, a width, a thickness, and at least one cutout, having a first end and a second end; wherein said at least one attachment mechanism attaches at least one first grommet to at least one second grommet through said at least one cutout, and wherein said at least one first grommet, at least one second grommet, and at least one attachment mechanism, may slide from said first end to said second end. In some embodiments, this security apparatus further comprises a back plate and optionally a self-tapping screw.

There exist other embodiments, where the securing member further comprises a lip which preferably spans the height of said securing member. In additional embodiments, this apparatus also features a lock. This lock may comprise a cylinder, having face with a port to accept a key and a threaded outer perimeter. Preferably, the back plate has a hole sized to receive the threaded outer perimeter and the lock is a key lock. In the most preferable of embodiments, the securing member further comprises a space to allow a strike plate to pass through the present invention. In qualifying door frames, this is an essential component.

The present invention also contemplates a security system, comprising: at least one security apparatus, having an open position and a closed position, said at least one security apparatus, comprising: at least one first grommet; at least one second grommet; at least one attachment mechanism; and a securing member, having a height, a width, a thickness, and at least one cutout; wherein said at least one attachment mechanism attaches at least one first grommet to at least one second grommet through said at least one cutout; at least one closing mechanism, capable of moving said at least one security apparatus from said open position into said closed position. Preferably, a latch is positioned to hold the security apparatus in the open position. In other embodiments, the closing mechanism further comprises a memory, for holding computer-readable instructions; a processor, for executing said computer-readable instructions; a communications controller, for interfacing with said at least one security apparatus; said at least one closing mechanism being in electronic communication with said communications controller. In other embodiments, the closing mechanism further comprises a spring, wherein said spring, when relaxed, placed said at least one security apparatus in the closed position and optionally a motor that places said at least one security apparatus in the open position, wherein said motor is in electronic communication with said communications controller, and is capable of being activated and deactivated via said communications controller.

The present invention also teaches a method of securing a door, comprising: providing, a door having a height, a width, and a frame; providing, a security apparatus, comprising: at least one security apparatus, having an open position and a closed position, said at least one security apparatus, comprising: at least one first grommet; at least one second grommet, attached to a back plate, said back plate having at least one hole; at least one attachment mechanism; and a securing member, having a height, a width, a thickness, a cylinder, having face with a port to accept a key and a threaded outer perimeter where turning said key will turn said threaded outer perimeter, and at least one cutout having a first end and a second end; wherein said at least one attachment mechanism attaches at least one first grommet to at least one second grommet through said at least one cutout; attaching, said at least one security apparatus, to said frame with said back plate abutting said frame; sliding, said at least one security apparatus, such that said at least one attachment mechanism, at least one first grommet, and at least one second grommet travel from said first end of at least one cutout to said second end of at least one cutout, and such that said threaded outer perimeter is proximate to said at least one hole; turning, said key, such that the threaded outer perimeter will thread through said at least one hole.

In general, the present invention succeeds in conferring the following, and others not mentioned, benefits and objectives.

It is an object of the present invention to provide a device that can be retro-fitted into existing schools.

It is an object of the present invention to provide a device that can secure apartments, condominiums, townhouses, and other dwellings.

It is an object of the present invention to provide an inexpensive way to secure doors.

It is an object of the present invention to promote safety.

It is an object of the present invention to provide a device that can secure a door while in use, but be hidden away when not in use.

It is an object of the present invention to provide a comprehensive, linked, security system that is capable of quickly and remotely securing at least a portion of an entire building.

### BRIEF DESCRIPTION OF THE DRAWINGS

FIG. 1 is a front view of an embodiment of the device of the present invention, installed on a standard door frame.

FIG. 2 is an alternative front view of an embodiment of the device of the present invention, installed on a standard door frame.

FIG. 3 is a top view of an embodiment of the device of the present invention, installed on a standard door frame.

FIG. 4 is a top view of an embodiment of the device of the present invention, featuring the back plate of the present invention.

FIG. 5 is a top view of an embodiment of the lock mechanism of the present invention.

FIG. 6 is a top view of an alternative embodiment of the device of the present invention, installed on a door frame.

FIG. 7 is a front view of an alternative embodiment of the device of the present invention, installed on a standard door frame.

FIG. 8 is a front view of an embodiment of the space of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

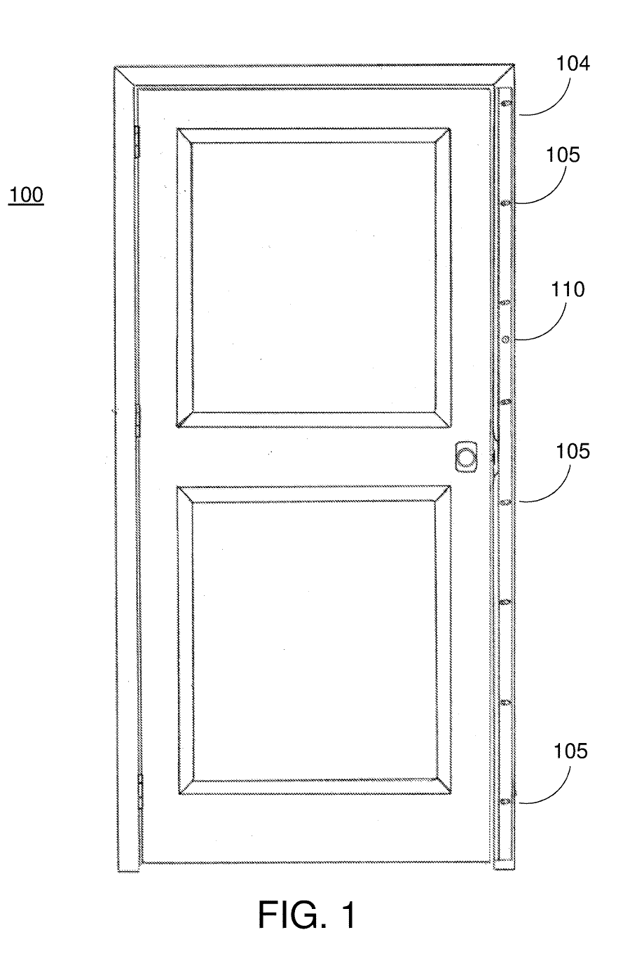

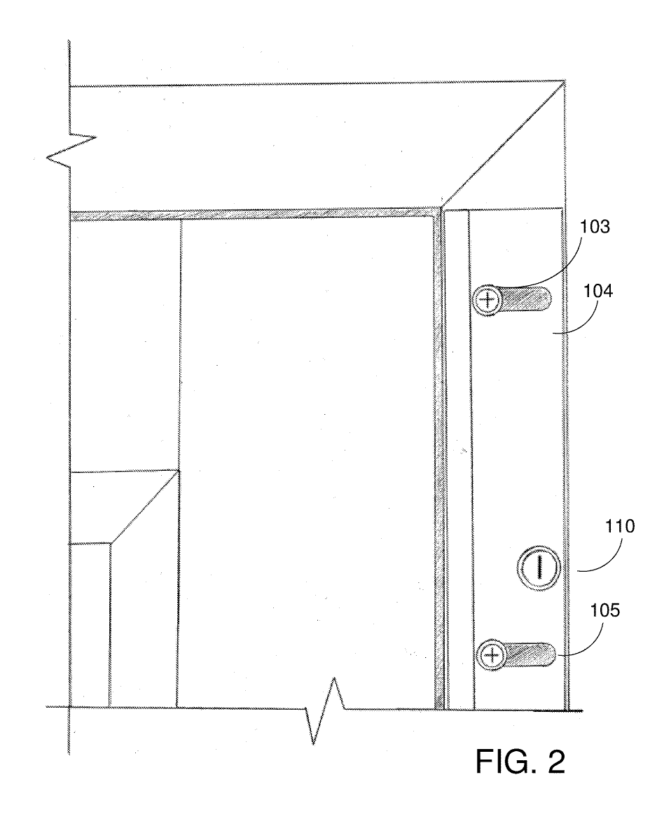

Referring to FIG. 1, a front view of an embodiment of the device of the present invention, installed on a standard door frame is shown. It should be noted that the door and door frame are not part of the claimed invention and are provided for some contextual background. Here, security apparatus 100 comprises securing member 104, at least one cutout 105, and lock 110. While the present invention contemplates security apparatus 100 with a single cutout 105, in other preferred embodiments, the security apparatus can have as many cutouts 105 as needed, provided that the cutouts 105 are never closer than 0.5 inches apart. This is to allow for enough of securing member 104 (See FIG. 2), to have enough material between cutouts 105 such that security apparatus 100 can withstand a large amount of force being exerted on it without breaking. Preferably, security apparatus 100 will have 8 evenly spaced cutouts 105 when security apparatus 100 is sized to accommodate the full length of a standard door, or 80 inches. It should also be noted that while in FIG. 1, security apparatus 100 spans the full length of the door, there exist alternative embodiments where security apparatus spans less than the full length of a door, such as ¾ of a standard door frame (60 inches), or ½ of a standard door frame (40 inches). In another preferred embodiment, security apparatus 100 is 70 inches.

The present invention operates by being installed on a door frame or proximate to a door, if no frame is present. The device is preferably installed on the latch-side of the door. The present invention operates by switching from the closed position to the open position. The closed position is what is displayed in FIG. 1. That is, security device 100 is aligned only with the frame of a door that is to be secured. When desired, the present invention can be moved (either manually or automatically, depending on the embodiment) to the open position where security apparatus 100 extends beyond the frame and overlaps with the door. In the open position, when an entity attempts to open the door proximate to security apparatus 100, the door shall abut against security apparatus 100 and will not be able to open. The embodiment shown in FIG. 1 features lock 110 which can be used to secure security apparatus 100 in either the open or closed position. In various embodiments the present invention can be constructed out of steel, aluminum, brass, gold, silver, bronze, platinum, stainless steel, titanium, or some combination thereof.

FIG. 2 shows an alternative front view of an embodiment of the device of the present invention, installed on a standard door frame. Here a close-up of the embodiment of security apparatus 100 shown in FIG. 1 is provided. This view shows at least one attachment mechanism 103, securing member 104, at least one cutout 105, and lock 110. As can be seen by this view, at least one attachment mechanism 103 is fixed to the door frame (or portion of a wall proximate to a door) and is located inside at least one cutout 105. This allows securing member 104 to slide the width of at least one cutout 105. Preferably at least one cutout 105 is 1.25 inches wide, however, the width of at least one cutout 105 can range from ½ inch to 12 inches, provided that securing member 104 is sufficiently wide to accommodate such a width of at least one cutout 105. Preferably, this width is 2 inches to 6 inches. If multiple cutouts 105 exist in a particular embodiment, it is important that cutouts 105 are parallel with each other. That is, cutouts 105 must be oriented such that securing member 104 can slide between the open and closed positions.

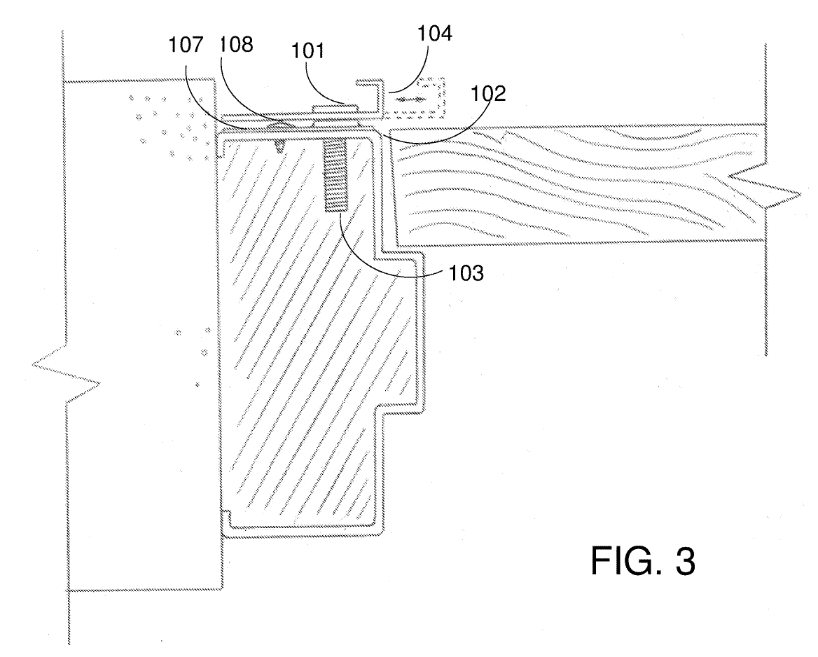

Referring to FIG. 3 a top view of an embodiment of the device of the present invention, installed on a standard door frame is shown. Here, the present invention features at least one first grommet 101, at least one second grommet 102, at least one attachment mechanism 103, securing member 104, back plate 107 and self-tapping screw 108. Here, the relationship of first grommet 101, second grommet 102, attachment mechanism 103 and securing member 104 is highlighted. As can be seen, first grommet 101 and second grommet 102 flank securing member 104. These components are then attached by attachment mechanism 103. Attachment mechanism 103 is located in at least one cutout 105 (See FIG. 2). This allows the position of attachment mechanism 103, first grommet 101, and second grommet 102 to remain constant while the present invention switches from the open to the closed position. As can be seen, attachment mechanism 103 attaches to the frame of a door. FIG. 3 also shows back plate 107 and self-tapping screw 108, which are included in some, but not all embodiments of the present invention. Back plate 107 serves to provide a flat surface for the remainder of the present invention to attach to. While the frame shown in FIG. 3 is not damaged, frequently door frames are not perfectly flush, or are not perfectly parallel with the door. The alignment of the present invention in relation to door/door frame that it is attached to is important. The present invention operates better when there is limited space between the door and securing member 104. Preferably this distance is ⅛ of an inch. Self-tapping screw 108 is used to secure back plate 107 to a door frame before first grommet 101, second grommet 102, securing member 104, and attachment mechanism 103 are secured to the door frame. Back plate 107 is preferably 1/16 inches thick.

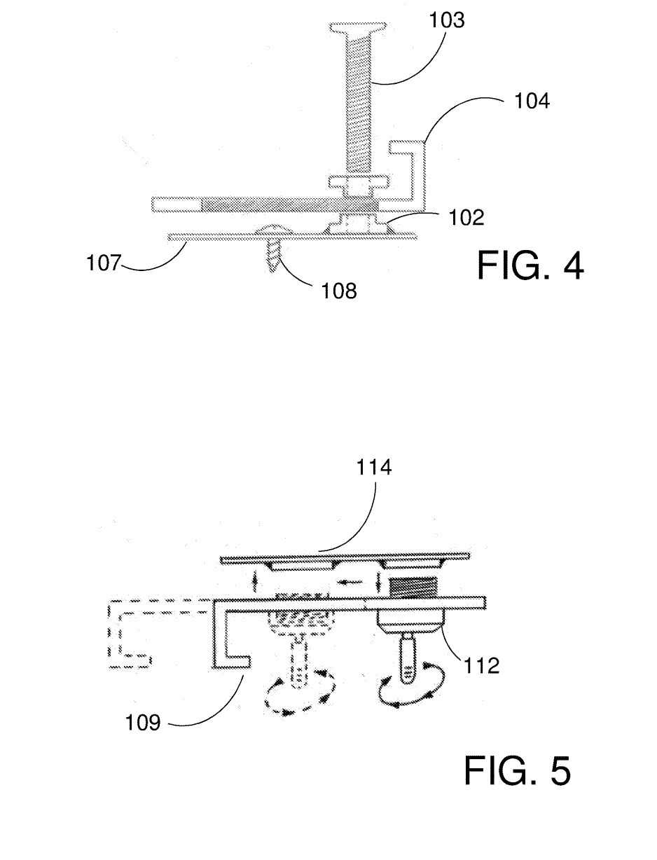

FIG. 4 is a top view of an embodiment of the device of the present invention, featuring the back plate of the present invention. This view features second grommet 102, securing member 104, attachment mechanism 103, back plate 107, and self-tapping screw 108. This view provides further insight into how the present invention slides between the open and closed positions by showing the relationship of the various components.

FIG. 5 is a top view of an embodiment of the lock mechanism of the present invention. This embodiment of the present invention shows lip 109, lock 112, and hole 114. Lock 112 is featured on many embodiments, and can be a valuable addition to the present invention in many circumstances. Lock 112 operates by securing the present invention in either the open or closed position. Lock 112 consists of a port and a threaded outer perimeter. This outer perimeter screws into hole 114 of an appropriately-configured back plate. Preferably, the present invention features two of hole 114, such that one of hole 114 is located such that the threaded outer cylinder may be screwed into it while the present invention is in the open position, and another of hole 114 located in a position that lock 112 can be used to secure the present invention in the open position. When a user would like to toggle the position of an embodiment of the present invention that has been secured by lock 112, the user may insert a key into the port of lock 112, and can turn it such that the threaded outer perimeter disengages with hole 114. Lip 109 is provided to make it easier to grip the present invention and move it from one position to another. Alternatively, lock 112 may employ magnets instead of the threaded outer perimeter described above. In a preferred embodiment, lock 112 employs a biometric scanner to operate lock 112.

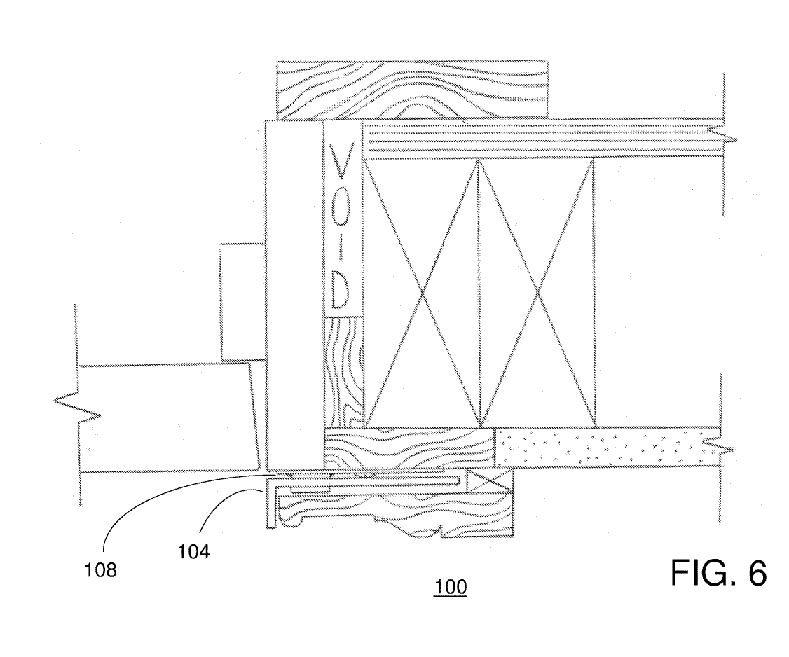

Referring to FIG. 6, a top view of an alternative embodiment of the device of the present invention, installed on a residential door frame is shown. This embodiment has been configured for residential use. As can be seen, the present invention is located behind some trim, allowing the present invention to be unobtrusive in a residential or educational setting. This provides the benefit of allowing a user to secure their doors, but in a way that will not upset a child, something that is paramount in maintaining a comfortable home, or an effective learning environment.

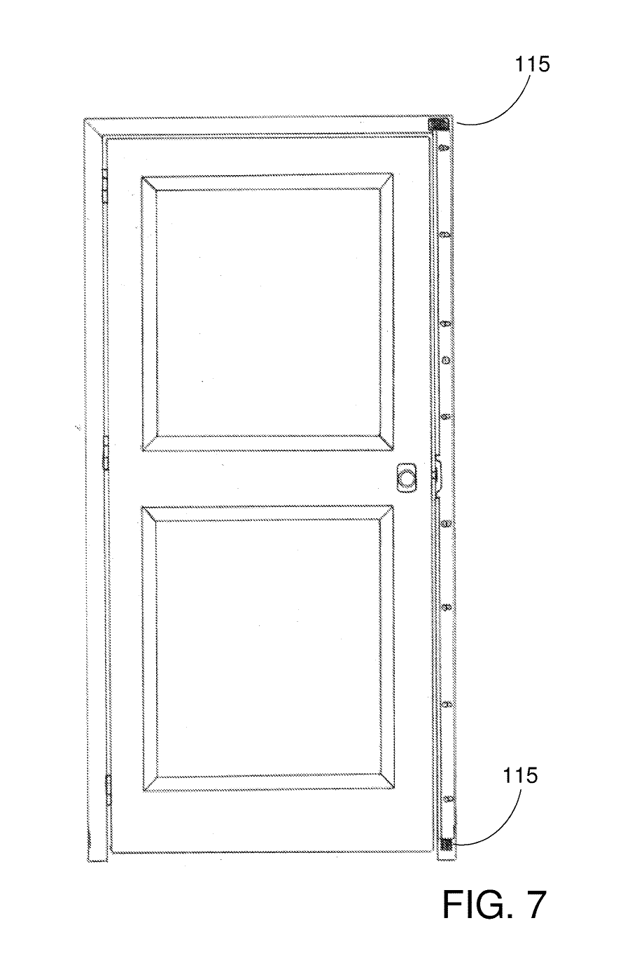

FIG. 7 is a front view of an alternative embodiment of the device of the present invention, installed on a standard door frame. This embodiment features closing mechanism 115, which is preferably a motor. In some embodiments, the present invention comprises a security system, consisting of a number of linked security apparatuses. These linked security apparatuses are controlled by a communications controller that allows for an entire building to be secured by the present invention. In some embodiments, these security apparatuses can be triggered by a central alarm. When this central alarm is triggered, all of the linked security apparatuses will automatically move from the closed to the open position by closing mechanism 115. In other embodiments, when a single security apparatus is closed, all other linked security apparatuses will be closed automatically by closing mechanism 115. In another preferred embodiment, the present invention can be operated via an internet-enabled remote control, or through a software application running on an internet-enabled smartphone.

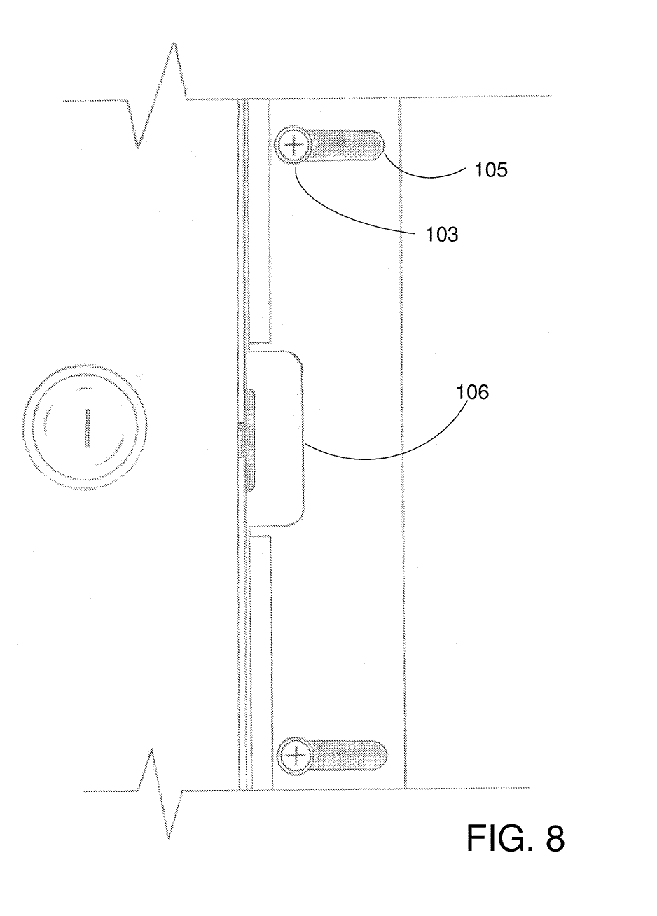

FIG. 8 shows a front view of an embodiment of the space of the present invention. Here, the present invention features at least one cutout 105, at least one securing mechanism and space 106. Many modern door frames are equipped with a strike plate that extends beyond the frame to guide the lock of the door into the appropriate position. When a door frame is equipped with a strikeplate that extends beyond the frame in this manner, the present invention must be equipped with space 106. This space ensures that the door is still operational while the present invention is in the closed position. When the present invention is installed right at the edge of the door frame, which is preferable, without space 106 the door will get stuck on the device rendering the entire entryway unusable.

In a preferred embodiment, the present invention further comprises a latch for holding the present invention in the open or closed position, depending on the location of the latch.

What is claimed is:

1. A security apparatus, comprising:
at least one first grommet;
at least one second grommet;
at least one attachment mechanism; and
a securing member, having
a height,
a width,
a thickness, and
at least one cutout, having a first end and a second end;
wherein said at least one attachment mechanism attaches at least one first grommet to at least one second grommet through said at least one cutout, and wherein said at least one first grommet, at least one second grommet, and at least one attachment mechanism, may slide from said first end to said second end.

2. The security apparatus of claim 1, further comprising a back plate.

3. The security apparatus of claim 2 further comprising a self-tapping screw.

4. The security apparatus of claim 1, wherein said securing member further comprises a lip.

5. The security apparatus of claim 4, wherein said lip spans the height of said securing member.

6. The security apparatus of claim 1, further comprising a lock.

7. The security apparatus of claim 6, wherein said lock comprises:
a cylinder, having face with a port to accept a key and a threaded outer perimeter.

8. The security apparatus of claim 7 wherein said back plate has a hole sized to receive the threaded outer perimeter.

9. The security apparatus of claim 8, wherein said lock is a key lock.

10. The security apparatus of claim 1, where said securing member further comprises a space.

11. The security apparatus of claim 1, wherein said height ranges from 80 inches to 84 inches.

12. The security apparatus of claim 1, wherein said thickness ranges from ⅛ inches to 2 inches.

13. The security apparatus of claim 1, wherein said security apparatus has 8 cutouts.

14. The security apparatus of claim 1, wherein said securing member is constructed out of a material selected from the group consisting of: steel, aluminum, brass, gold, silver, bronze, platinum, stainless steel, and titanium.

15. A security system, comprising:
at least one security apparatus, having an open position and a closed position, said
at least one security apparatus, comprising:
at least one first grommet;
at least one second grommet;
at least one attachment mechanism; and
a securing member, having
a height,
a width,
a thickness, and
at least one cutout;
wherein said at least one attachment mechanism attaches at least one first grommet to at least one second grommet through said at least one cutout;
at least one closing mechanism, capable of moving said at least one security apparatus from said open position into said closed position.

16. The security system of claim 15, further comprising a latch positioned to hold the security apparatus in the open position.

17. The security system of claim 15, said closing mechanism further comprising:
a memory, for holding computer-readable instructions;
a processor, for executing said computer-readable instructions;
a communications controller, for interfacing with said at least one security apparatus;
said at least one closing mechanism being in electronic communication with said communications controller.

18. The security system of claim 15, said closing mechanism further comprising:
a spring,
wherein said spring, when relaxed, placed said at least one security apparatus in the closed position.

19. The security system of claim 15, said closing mechanism further comprising:
a motor that places said at least one security apparatus in the open position.
wherein said motor is in electronic communication with said communications controller, and is capable of being activated and deactivated via said communications controller.

20. A method of securing a door, comprising:
providing, a door having a height, a width, and a frame;
providing, a security apparatus, comprising:
at least one security apparatus, having an open position and a closed position, said at least one security apparatus, comprising:
at least one first grommet;
at least one second grommet, attached to a back plate,
said back plate having at least one hole;
at least one attachment mechanism; and
a securing member, having
a height,
a width,
a thickness,
a cylinder, having face with a port to accept a key and a threaded outer perimeter where turning said key will turn said threaded outer perimeter, and
at least one cutout having a first end and a second end;
wherein said at least one attachment mechanism attaches at least one first grommet to at least one second grommet through said at least one cutout;
attaching, said at least one security apparatus, to said frame with said back plate abutting said frame;
sliding, said at least one security apparatus,
such that said at least one attachment mechanism, at least one first grommet, and at least one second grommet travel from said first end of at least one cutout to said second end of at least one cutout, and
such that said threaded outer perimeter is proximate to said at least one hole;
turning, said key, such that the threaded outer perimeter will thread through said at least one hole.
